(19) United States
(12) Patent Application Publication
(10) Pub. No.: US 2023/0297427 A1
(43) Pub. Date: Sep. 21, 2023

(54) CONFIDENTIALITY BASED INTELLIGENT TASK ROUTING

(71) Applicant: INTERNATIONAL BUSINESS MACHINES CORPORATION, Armonk, NY (US)

(72) Inventors: Sudheesh S. Kairali, Kozhikode (IN); Sarbajit K. Rakshit, Kolkata (IN)

(21) Appl. No.: 17/697,997

(22) Filed: Mar. 18, 2022

(51) Int. Cl. G06F 9/50

(52) U.S. Cl. CPC G06F 9/5027

(57) ABSTRACT

Described are techniques for confidentiality-based intelligent task routing, including an intelligent routing method. The method may comprise processing, by a first instance of an application, a plurality of tasks at a high security level, receiving a new task from a user, and determining that the first instance cannot process the new task. The method may further comprise, in response to determining that the first instance cannot process the new task, analyzing the new task to determine an associated confidentiality level, creating a second instance of the application to process the new task at the associated confidentiality level, and processing the new task using the second instance at the associated confidentiality level.

### BACKGROUND

The present disclosure relates to computer security, and more specifically, to a confidentiality-based intelligent task routing service mesh.

The development of the EDVAC system in 1948 is often cited as the beginning of the computer era. Since that time, computer systems have evolved into extremely complicated devices. Today’s computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the relatively higher performance of those capabilities, resulting in computer systems today that are more powerful than just a few years ago.

Today, many such data processing systems store and/or process sensitive information. To protect that information, many organizations utilize data confidentiality levels to control how that information is stored and/or processed. An example set of data confidentiality levels, and the corresponding security measures, is listed below:
Restricted: Data should be classified as Restricted when the unauthorized disclosure, alteration or destruction of that data could cause a significant level of risk to the user/customer of the system. Examples of Restricted data include data protected by state or federal privacy regulations and data protected by confidentiality agreements. The highest level of security controls should be applied to Restricted data.
Private: Data should be classified as Private when the unauthorized disclosure, alteration or destruction of that data could result in a moderate level of risk to the user/customer of the system. By default, all Institutional Data that is not explicitly classified as Restricted or Public data should be treated as Private data. A reasonable level of security controls should be applied to Private data.
Public: Data should be classified as Public when the unauthorized disclosure, alteration or destruction of that data would result in little or no risk to the user/customer of the system. Examples of Public data include press releases, course information and research publications. While little or no controls are required to protect the confidentiality of Public data, some level of control is required to prevent unauthorized modification or destruction of Public data.

### SUMMARY

According to embodiments of the present disclosure, an intelligent routing method, comprising processing, by a first instance of an application, a plurality of tasks at a high security level, receiving a new task from a user, and determining that the first instance cannot process the new task. The method may further comprise, in response to determining that the first instance cannot process the new task, analyzing the new task to determine an associated confidentiality level, creating a second instance of the application to process the new task at the associated confidentiality level, and processing the new task using the second instance at the associated confidentiality level. In some embodiments, the analyzing of the new task comprises using a machine learning model trained to predict the associated confidentiality level for the new task. In some embodiments, the method may further comprise receiving a plurality of additional tasks from a plurality of users, and routing the plurality of additional tasks to the first instance or the second instance based on their predicted associated confidentiality levels. In some embodiments, the first instance of the application processes tasks using a higher level of network security than the second instance of the application. In some embodiments, the first instance of the application and the second instance of the application each comprise respective first and second chains of microservices, wherein the first and second chains of microservices are each connectable by multiple users. In some embodiments, creating a second instance of the application with the associated confidentiality level comprises identifying a level of confidentiality level for each microservice in the second chain of microservices. In some embodiments, determining that the first instance can process the new task comprises determining that a number of current users exceeds a threshold. In some embodiments, the method may further comprise changing task routing to move at least some of a plurality of users to instances having lower security levels. In some embodiments, moving at least some of the plurality of users comprises creating a user profile for each of the plurality of users, periodically monitoring each user profile, and calculating a confidentiality level for each of the plurality of users using the user profiles. In some embodiments, the method may further comprise monitoring a number of active users for each instance of the application and, responsive to the number of active users of a current instance being less than a predefined minimum number of profiles, moving all users of the current instance to a higher security instance, and removing the current instance.

According to embodiments of the present disclosure, a computer readable storage medium having program instructions embodied therewith, the program instructions executable by a computer to perform a method. The method may comprise processing, by a first instance of an application, a plurality of tasks at a high security level, receiving a new task from a user; and determining that the first instance cannot process the new task. The method may further comprise, in response to determining that the first instance cannot process the new task, analyzing the new task to determine an associated confidentiality level, creating a second instance of the application to process the new task at the associated confidentiality level, and processing the new task using the second instance at the associated confidentiality level.

According to embodiments of the present disclosure, a system for intelligent routing, the system comprising one or more processors, and a memory communicatively coupled to the one or more processors. The memory may comprise instructions which, when executed by the one or more processors, cause the one or more processors to perform a method. The method may comprise processing, by a first instance of an application, a plurality of tasks at a high security level, receiving a new task from a user; and determining that the first instance cannot process the new task. The method may further comprise, in response to determining that the first instance cannot process the new task, analyzing the new task to determine an associated confidentiality level, creating a second instance of the application to process the new task at the associated confidentiality level, and processing the new task using the second instance at the associated confidentiality level.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system (DPS), consistent with some embodiments.

FIG. 2 illustrates one embodiment of a cloud environment suitable for enabling a confidentiality-based intelligent task routing service mesh, consistent with some embodiments.

FIG. 3 shows a set of functional abstraction layers provided by a cloud computing environment, consistent with some embodiments.

FIG. 4A depicts an example monolithic service architecture, consistent with some embodiments.

FIG. 4B depicts an example microservice-based architecture, consistent with some embodiments.

FIG. 5A is a first flow chart of one embodiment of an intelligent routing system in operation.

FIG. 5B is a second flow chart of one embodiment of the intelligent routing system in operation.

FIG. 6 is a system diagram showing one embodiment of the intelligent routing system in more detail.

FIGS. 7A and 7B (collectively FIG. 7) are a flow chart illustrating one method of implementing the intelligent routing system in FIGS. 5A-5B within a service mesh architecture, consistent with some embodiments.

FIG. 8A illustrates an example machine learning model (ML model), consistent with some embodiments.

FIG. 8B depicts one embodiment of a ML model training method.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer security; more particular aspects relate to a confidentiality-based intelligent task routing service mesh. While the present disclosure is not necessarily limited to such applications, various aspects of the disclosure may be appreciated through a discussion of various examples using this context.

In many organizations, multiple users can connect to and/or use the same software applications (e.g., in a cloud server), but may be performing tasks and/or processing data having different confidentiality levels. That is, even though multiple users are using the same application, the confidentiality levels of their respective tasks may differ for a variety of reasons. For example, one user may be using a finance application to upload medical expenses to be processed using a highest confidentiality level, whereas another user may be using that same finance application to perform tax calculations that only require an intermediate confidentiality level.

The security measures utilized by higher confidentiality levels, however, are not free. The cost for performing a calculation is typically based on an amount of computing resources consumed, which may include network security, application security, and storage security measures. Taken together, higher data confidentiality levels will generally trigger higher levels of security, which will generally utilize more computing resources, and thus, result in higher costs. One problem is that, if an application is configured to satisfy the needs of the users and/or tasks having the highest confidentiality needs, the resulting security measures may be unnecessary for other users and/or tasks.

Accordingly, some embodiments of the present disclosure include a method and system by which each user’s activities may be automatically analyzed to identify an associated confidentiality level. Some embodiments may enable a plurality of users and/or tasks to be segmented based on their associated confidentiality level(s) to different instances of an application (and/or chains of microservices that comprise the application). These different instances of the application may enforce different levels of security (e.g., network security). In this way, the system’s use of computing resources as-a-whole may be reduced.

Some embodiments of the present disclosure may identify, within a single instance of an application, that multiple users are connected (e.g., submitting tasks to the instance), then identify the highest level of confidentiality level required by the associated user(s) and/or task(s), then apply the security requirements associated with that highest level. If the number of users exceeds a predetermined threshold, then the system may create a new instance of the application for users and/or tasks having lower confidentiality requirements. In some embodiments, the users and/or tasks having lower confidentiality requirements may be automatically moved to the new instance by applying dynamic changes in task routing.

In some embodiments, a current number of users and/or tasks using each instance of the application may be monitored. If the current number of users and/or tasks falls below a predetermined minimum threshold, then one or more lower security instances of the application may be removed. The users and/or tasks using that instance may be moved to one of the higher security instances.

In some embodiments, each user and/or task may have an associated profile comprising a confidentiality level. These profiles may be used to dynamically route the users and/or tasks to the appropriate instance(s). These profiles may also be periodically monitored and, if a user and/or task is currently exhibiting a different confidentiality level than specified in the profile, that user/task may be moved to the appropriate instance and the profile may be updated.

In some embodiments, the system may use a machine learning model to predict a confidentiality level associated with each new task. Some embodiments may use the predicted confidentiality level(s) to determine if new instances of an application should be created, should be removed, and/or to dynamically route users and/or tasks to the appropriate instances. The machine learning model may be trained using a historical knowledge corpus in some embodiments.

In some embodiments, the application may comprise a chain of microservices. The system in these embodiments may identify a level of security used by each microservice in each chain, and may use the identified security levels to calculate a maximum confidentiality level that can be processed by that chain. Some embodiments may replicate the chains of microservices if there are too many users with dissimilar confidentiality needs, and the replicated chains may have different security levels (e.g., sets of network policies). In some embodiments, these security levels may be customized based on the specific set of users using (or to be transferred to) that chain.

### Data Processing System (DPS)

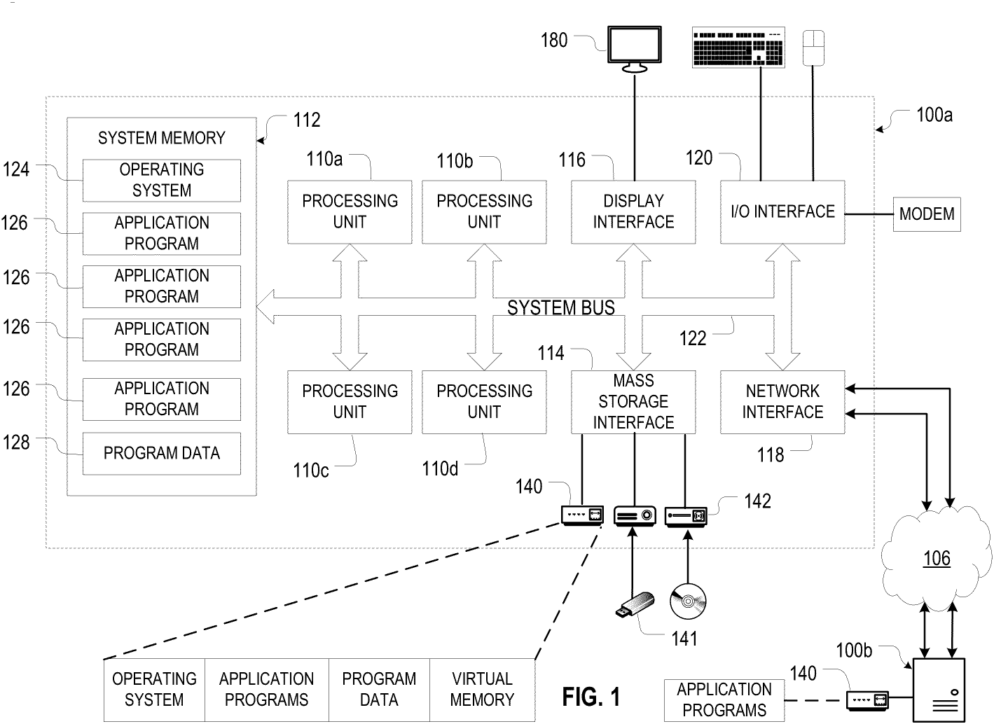

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and the number, type, and configuration of such components may vary.

The DPS 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interface 114 in this embodiment may connect the system bus 122 to one or more mass storage devices, such as a direct access storage device 140, a USB drive 141, and/or a readable/writable optical disk drive 142. The network interface 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the DPS 100 may only comprise a single processor system and/or a single processor designed to emulate a multiprocessor system. Further, the processor(s) 110 may be implemented using a number of heterogeneous data processing systems in which a main processor 110 is present with secondary processors on a single chip. As another illustrative example, the processor(s) 110 may be a symmetric multiprocessor system containing multiple processors 110 of the same type.

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like. The I/O interface 120 may support attachment of one or more I/O devices, such as a keyboard, mouse, modem, or printer (not shown)

The terminal/display interface 116 may be used to directly connect one or more displays 180 to the DPS 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the DPS 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### Cloud Computing

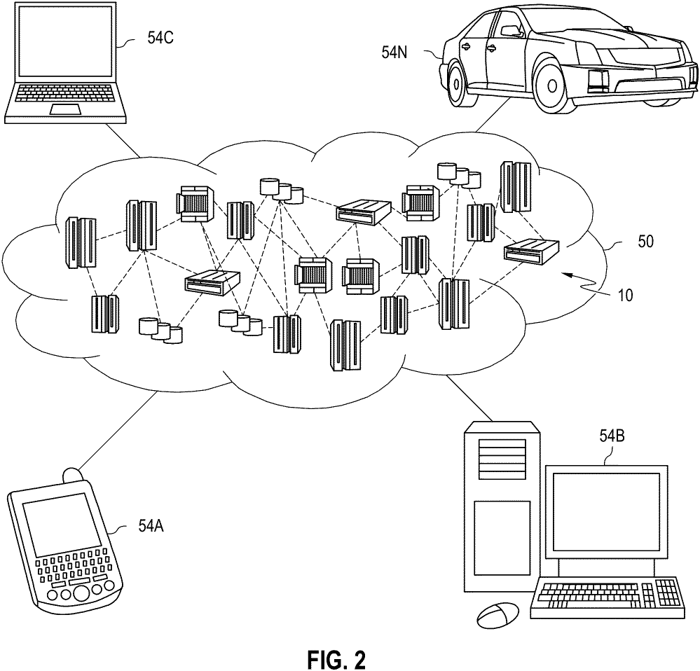

FIG. 2 illustrates one embodiment of a cloud environment suitable for enabling a confidentiality-based intelligent task routing service mesh. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service’s provider.
Broad network access: capabilities are available over a network and accessed through standard mechanisms that promote use by heterogeneous thin or thick client platforms (e.g., mobile phones, laptops, and PDAs).
Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

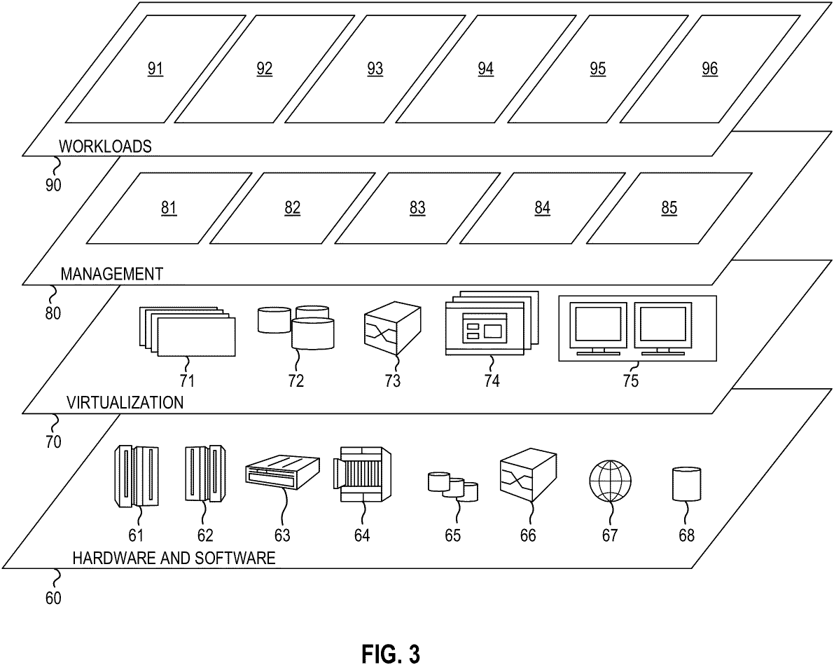

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and intelligent routing system 96.

### Application Architecture

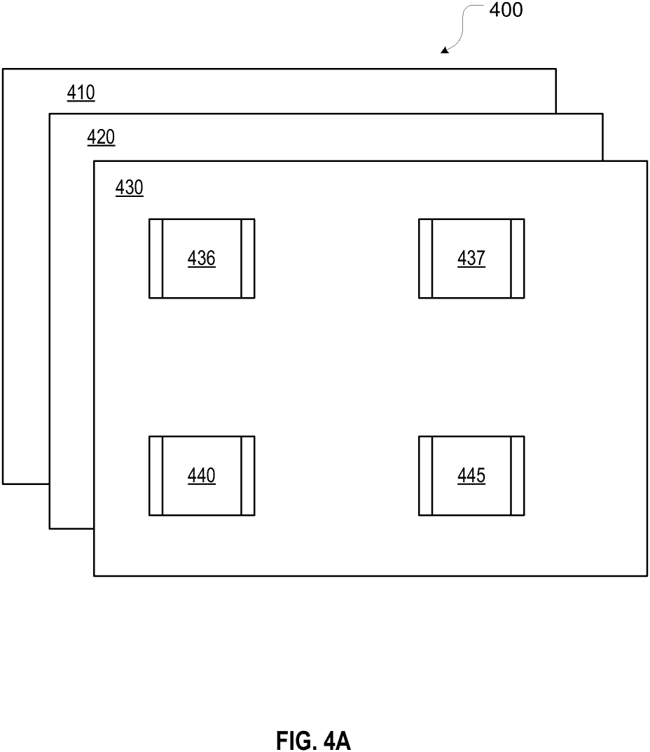

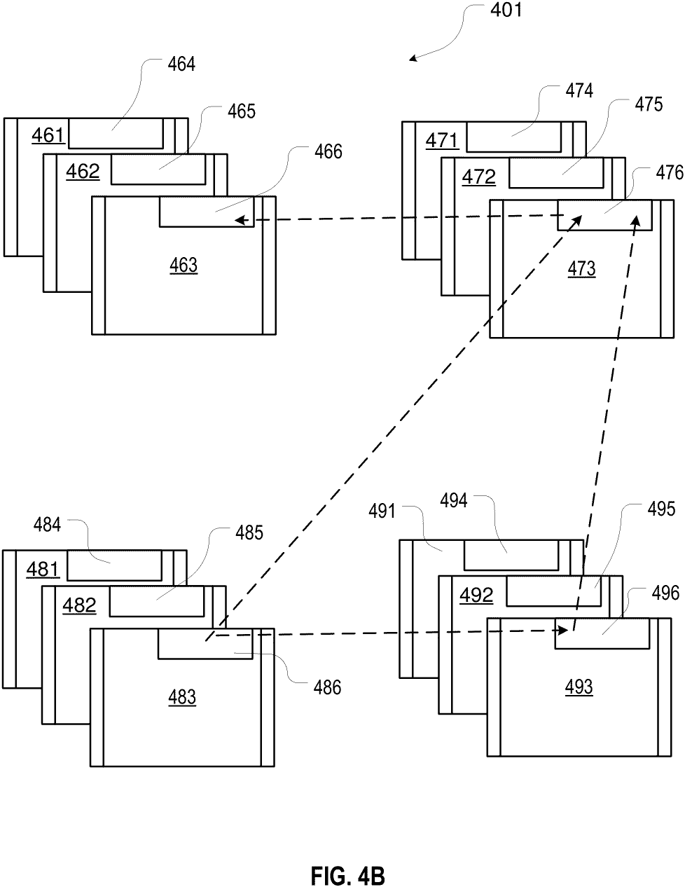

FIG. 4A depicts an example monolithic service architecture, while FIG. 4B depicts an example microservice-based architecture, both suitable for use with some embodiments. In the architecture of FIG. 4A, the monolithic service 400 may include a plurality of service instances 410, 420, and 430 of an application, which may be executing on one or more DPS 100 (not shown). Each of these service instances may comprise one or more distinct features/functionalities, such as functions 436, 437, 440, and/or 445 (only shown in service instance 430 for clarity). These distinct functionalities may, for example, enable different levels of security for each of the service instances 410, 420, 430.

In the microservice architecture 401 in FIG. 4B, applications may be structured as a loosely-coupled (e.g., fine-grained) collection of small, well-defined stateless service (referred to as microservices) instances 461-463, instances 471-473, instances 481-483, and instances 491-493 executing on one or more DPS 100 (not shown). These microservices may communicate with each other only through well-defined application programming interfaces (APIs) to form an application. Thus, an application generally corresponding to service instance 410 (shown in FIG. 4A) may comprise a chain consisting of microservices 461, 471, 471, and 481; and an application generally corresponding to service instance 420 (shown in FIG. 4A) may comprise a chain consisting of microservices 462, 472, 472, and 482.

As discussed above, each instance of microservice instance may include a well-defined API. Thus, for example, microservices 461, 462 and 463 may include respective APIs 464, 465 and 466. Microservices 471, 472 and 473 may include respective APIs 474, 475 and 476. Microservices 481, 482 and 483 may include respective APIs 484, 485 and 486. Microservices 490, 491, 492 and 493 may include respective APIs 494, 495 and 496. These microservices may communicate with each other through their APIs. Thus, in FIG. 4B, instance 473 may send data to API 466 of instance 463. Instance 473 may also receive data from and API 486 of instance 483 and API 496 of instance 493.

Each set of microservices e.g., 461, 462, and 463 may be configured to, for example, use different security rules to process data. For example, the chain consisting of microservices 461, 471, 481, and 491 may be configured to process data at a relatively higher security level and the chain consisting of microservices 462, 472, 482, and 492 may be configured to process data at a relatively lower security level. In this way, the different chains may enable different levels of security for each such chain.

### Intelligent Routing System

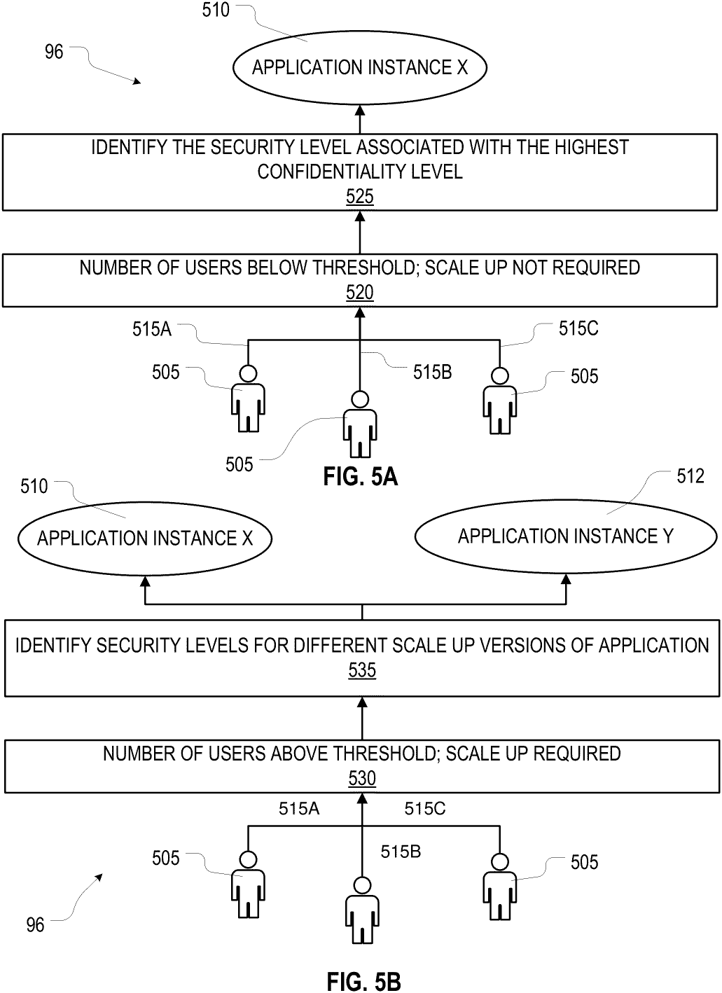

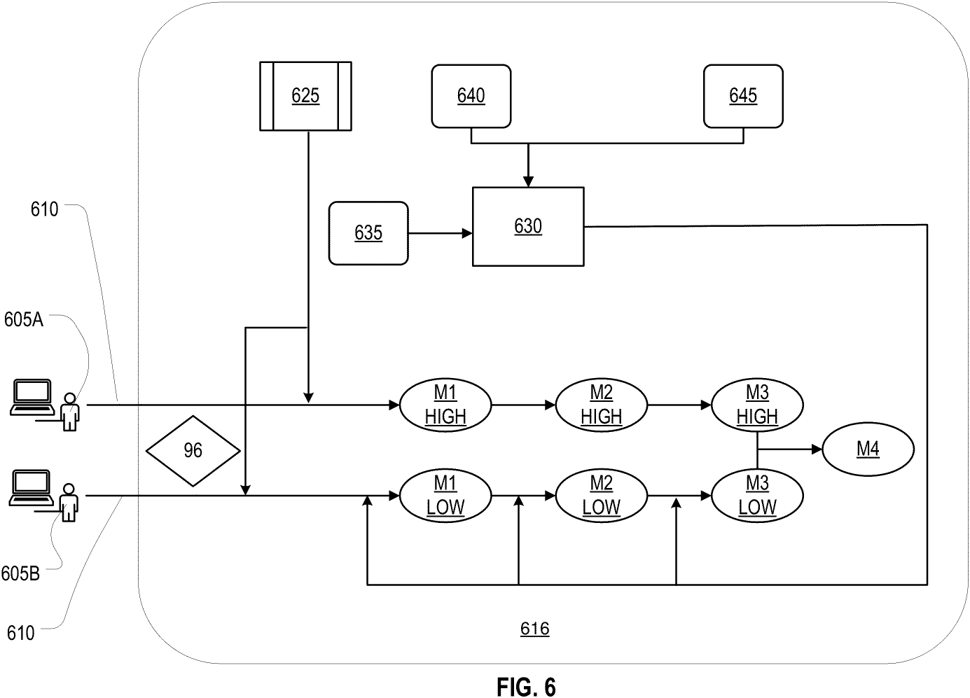

FIG. 5A is a first flow chart of one embodiment of the intelligent routing system 96 in operation. This embodiment of the intelligent routing system 96 is depicted as processing a first group of tasks 515A-515C from multiple users 505 who are connected to same instance of an application 510, such as application 410 (shown in FIG. 4A) or microservice chain 461, 471, 481, 491 (shown in FIG. 4B). In this example, some of the tasks 515A may require a relatively higher amount of security measures under the organization’s policies (e.g., they have a high confidentiality level), some of the tasks 515B may only require an intermediate amount of security measures (e.g., they have an intermediate confidentiality level), and some of the tasks 515C may only require a relatively lower amount of security measure (e.g., they have a low confidentiality level). In operation, if the intelligent routing system 96 identifies at operation 520 that the number of users 505 can be processed by the current instance X of the application 510, then the intelligent routing system 96 may identify the highest level of confidentiality required by any of the submitted tasks 515A-515C at operation 525, and then process all of the submitted tasks at that security level in the current instance X of the application 510.

FIG. 5B is a second flow chart of one embodiment of the intelligent routing system 96 in operation. In this example, the intelligent routing system 96 may determine at operation 530 that the existing instance of application 510 cannot process all of the tasks 515A-515C e.g., because a number of users is above a threshold. In response to this determination, the intelligent routing system 96 may scale up another instance of the application 512. In some embodiments, the intelligent routing system 96 may classify the users and/or users’ tasks based on their confidentiality levels at operation 535, and create different instances X and Y of the application. The intelligent routing system 96 may then route the users and/or tasks to appropriate instances of the application 510 based at least in part on the on determined confidentiality levels. In this way, a differentiated level of security (e.g., network security) may be enforced.

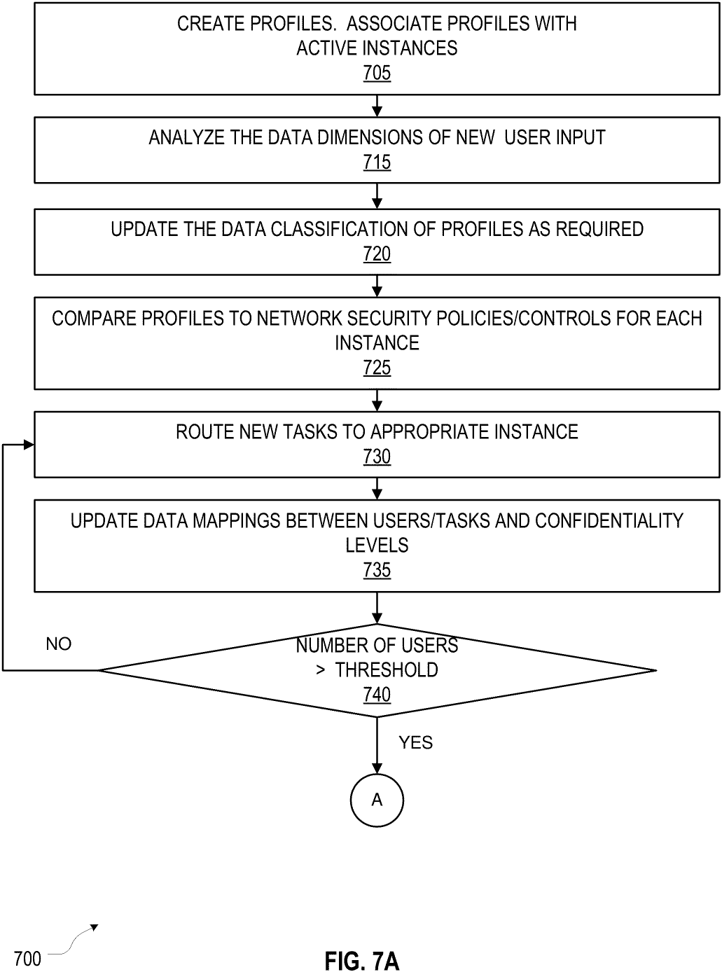

FIG. 6 is a system diagram showing one embodiment of the intelligent routing system 96 in more detail. This embodiment of the intelligent routing system 96 will be described with reference to an example involving a first user 605A who is performing typical tasks requiring a particular level of confidentiality, and a second user 605B who is performing tasks that require less confidentiality than the typical tasks. Both of these users 605 may submit tasks 610 to an application executing in a service mesh environment 616. The application, in turn, may comprise a chain of microservices. The intelligent task routing system 96 may route these tasks to either a relatively higher security version of the chain of microservices M1 HIGH, M2 HIGH, M3 HIGH, M4 or a relatively lower security version of the chain of microservices M1 LOW, M2 LOW, M3 LOW, M4. These two chains may produce the same output, but the higher security chain M1 HIGH, M2 HIGH, M3 HIGH, M4 may utilize more technical measures to protect the data they consume, e.g., encryption, M-TLS, etc.

In some embodiments, a user confidentiality assessment engine 625 may analyze incoming tasks 610 to determine a user confidentiality level that should be associated with that user and/or task. As will be discussed in more detail below, the user confidentiality assessment engine 625 may comprise a trained machine learning model.

Some embodiments may also include an intelligent microservice chain replicator 630 that may create new chains of microservices (e.g., M1 HIGH, M2 HIGH, M3 HIGH, M4) to meet demand. The intelligent microservice chain replicator 630 may utilize a compliance level and data confidentiality level to security controls mapping database 635, which may be configured by a system administrator via a security control center (SCC) (not shown). The intelligent microservice chain replicator 630 may also utilize a user-confidentiality mapping database 640 that maintains a plurality of user profiles, and maps those profiles to one of the confidentiality levels in the SCC. Some embodiments may also include a user-microservice chain mapping database 645 that maps confidentiality levels to configuration settings of the microservice chains M1 LOW, M2 LOW, M3 LOW, M4; and M1 HIGH, M2 HIGH, M3 HIGH, M4. As will be discussed in more detail below, the intelligent microservice chain replicator 630 may also comprise a trained machine learning model.

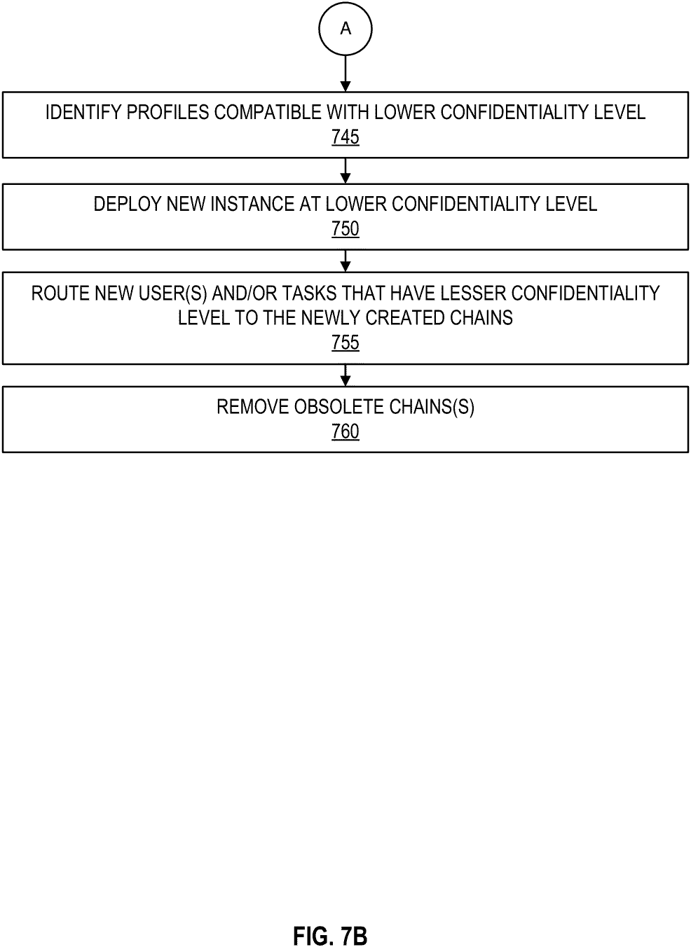

FIGS. 7A and 7B (collectively FIG. 7) are each parts of a flow chart illustrating one method 700 of implementing the intelligent routing system 96 in FIGS. 5A-5B within a service mesh architecture, consistent with some embodiments. At operation 705, the intelligent routing system 96 may create a user profile for each user and/or task, and then begin associating that profile with each of the active microservice chain(s) in which that user/task is participating. For example, the user may instruct the application 510 (shown in FIGS. 5A and 5B) to perform three tasks. Two of those tasks may be processed using a first microservice chain, and the third task may be processed using either the first microservice chain and a second microservice chain.

At operation 715, each user and/or task profile may be monitored for a current data confidentiality level associated with the tasks that the user is currently submitting. This may include, for each microservice chain in the service mesh, analyzing the data dimensions of the input using a corresponding proxy. In some embodiments, the service mesh control plane may further integrate with one of the data classification solutions. In other embodiments, the data dimension(s) may be based on pre-identified confidentiality configurations. At operation 720, the service mesh may update the data classification of user profiles, as necessary. If the user has switched to higher or lower confidentiality tasks since the last assessment, then the intelligent routing system 96 may change the associated level in the profile. These profiles may be securely stored in the user-confidentiality mapping database 640 (shown in FIG. 6).

At operation 725, a system administrator may provide (e.g., via the compliance level and data confidentiality level to security controls mapping database 635) “N” sets of network security policies/controls for each microservice, for each “N” number of data confidentiality levels. This may be downloaded from a cloud security command center (not shown). This mapping may be compared to the profiles for the current users/tasks. Based on the cloud security command center compliance goals, the new task may be routed to an appropriate instance of the application at operation 730. Initially, the service mesh may utilize security appropriate for the highest level of confidentiality at operation. Such checks and controls may be fetched from the security command center (e.g., from the compliance level and data confidentiality level to security controls mapping database 635 that the system admin can assign and maintain via the SCC).

Over a period of time, the service mesh may generate and/or update mappings between users and the data confidentiality levels at operation 735 and store them in the user-confidentiality mapping database 640 (shown in FIG. 6). If service mesh finds (at operation 740) that a considerable (e.g., greater than a configurable and/or adjustable threshold) number of users may utilize a lesser confidentiality level, the system may query the list of current microservice chains, analyze the associated user profiles, and identify profiles compatible with a lesser confidentiality level (at operation 745). The service mesh may then automatically deploy new instances of the microservices with lesser confidentiality levels for use by the identified, compatible users (at operation 750). That is, these newly created microservice chains may have lesser protection for data confidentiality, where lesser may be definable by the IT administrator in the security command center, consistent with the organizations goals for protection of these type(s) of tasks (e.g., the new chains may not utilize mutual-TLS between participating microservices). In this way, the new chains may be less resource intensive, and thus, less costly to operate.

New user(s) and/or tasks that have lesser confidentiality level may be automatically routed (e.g., using task routing based on user profiles) to the newly created chains at operation 755. Users may also be moved between chains based on their observed confidentiality. In some cases, chains may become obsolete if there are no active users. In such a situation, the obsolete chains(s) may optionally be removed at operation 760.

### Machine Learning

As previously discussed, the user confidentiality assessment engine 625 and the intelligent microservice chain replicator 630 (shown in FIG. 6) may comprise trained machine learning models (“ML models”). These ML models may be any software system that recognizes patterns in data sets. In some embodiments, the ML models comprise a plurality of artificial neurons interconnected through connection points called synapses. Each synapse encodes a strength of the connection between the output of one neuron and the input of another. The output of each neuron, in turn, is determined by the aggregate input received from other neurons that are connected to it, and thus by the outputs of these “upstream” connected neurons and the strength of the connections as determined by the synaptic weights.

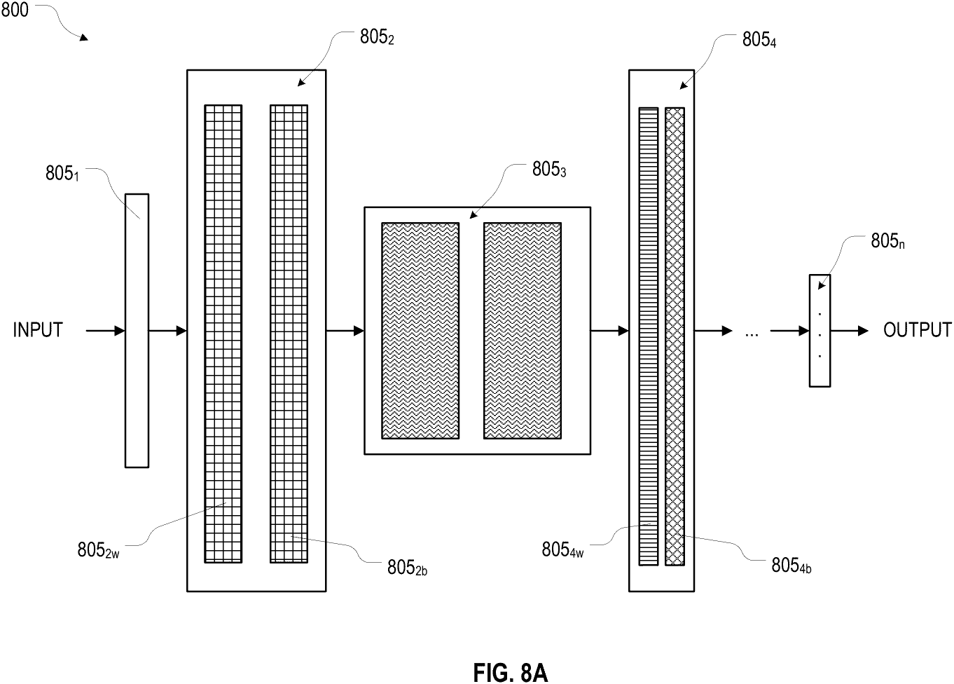

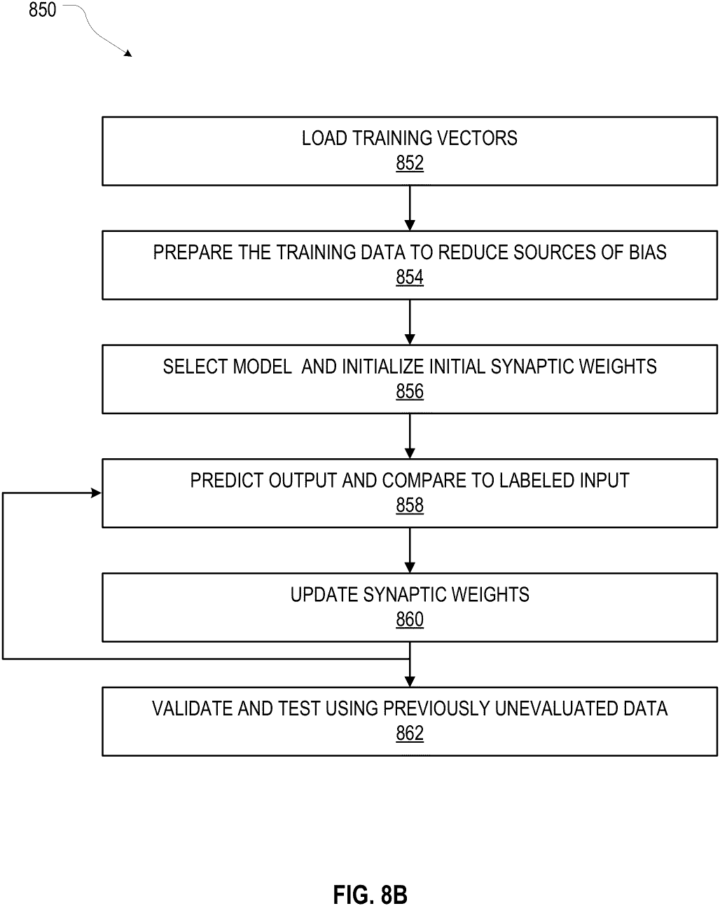

The ML models are trained to solve a specific problem (e.g., confidentiality assessment) by adjusting the weights of the synapses such that a particular class of inputs produce a desired output. This weight adjustment procedure in these embodiments is known as “learning.” Ideally, these adjustments lead to a pattern of synaptic weights that, during the learning process, converge toward an optimal solution for the given problem based on some cost function. In some embodiments, the artificial neurons may be organized into layers. FIG. 8A illustrates an example ML model 800, consistent with some embodiments. The ML model 800 comprises a plurality of layers 805₁-805ₙ. Each of the layers comprises weights 805_{1w}-805_{nw} and biases 805_{1b}-805_{nb} (only some labeled for clarity). The layer 805₁ that receives external data is the input layer. The layer 805ₙ that produces the ultimate result is the output layer. Some embodiments include a plurality of hidden layers 805₂-805ₙ₋₁ between the input and output layers, and commonly hundreds of such hidden layers. Some of the hidden layers 805₂-805ₙ₋₁ may have different sizes, organizations, and purposes than others of the hidden layers 805₂-805ₙ-₁. For example, some of the hidden layers in the ML model may be convolution layers, while other hidden layers may be fully connected layers, deconvolution layers, or recurrent layers.

Referring now to FIG. 8B, one embodiment of a ML model training method 850 is depicted, described with reference to confidentiality assessment as an illustrative example. At operation 852, the system receives and loads training data. In this example, the input data-set may include a plurality of tasks previously submitted by users and assigned a confidentiality level by an IT administrator. At operation 854, the training data is prepared to reduce sources of bias, typically including de-duplication, normalization, and order randomization. At operation 856, a model is selected for training and the initial synaptic weights are initialized (e.g., randomized). Depending on the underlying task, suitable models include, but are not limited to, feedforward techniques (e.g., convolutional neural networks), regulatory feedback-based systems, radial basis function (RBF) techniques, and recurrent neural network-based techniques (e.g., long short-term memory). At operation 858, the selected model is used to predict an output using the input data element, and that prediction is compared to the corresponding target data. A gradient (e.g., difference between the predicted value and the target value) is then used at operation 860 to update the synaptic weights. This process repeats, with each iteration updating the weights, until the training data is exhausted, or the model reaches an acceptable level of accuracy and/or precision. At operation 862, the resulting model may optionally be compared to previously unevaluated data to validate and test its performance.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a subsystem, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. An intelligent routing method, comprising:
processing, by a first instance of an application, a plurality of tasks at a high security level;
receiving a new task from a user;
determining that the first instance cannot process the new task;
in response to determining that the first instance cannot process the new task:
analyzing the new task to determine an associated confidentiality level;
creating a second instance of the application to process the new task at the
associated confidentiality level; and
processing the new task using the second instance at the associated confidentiality level.

2. The method of claim 1, wherein the analyzing of the new task comprises using a machine learning model trained to predict the associated confidentiality level for the new task.

3. The method of claim 2, further comprising:
receiving a plurality of additional tasks from a plurality of users; and
routing the plurality of additional tasks to the first instance or the second instance based on their predicted associated confidentiality levels.

4. The method of claim 1, wherein the first instance of the application processes tasks using a higher level of network security than the second instance of the application.

5. The method of claim 1, wherein:
the first instance of the application and the second instance of the application each comprise respective first and second chains of microservices, wherein the first and second chains of microservices are each connectable by multiple users.

6. The method of claim 5, wherein creating a second instance of the application with the associated confidentiality level comprises identifying a level of confidentiality level for each microservice in the second chain of microservices.

7. The method of claim 1, wherein determining that the first instance can process the new task comprises determining that a number of current users exceeds a threshold.

8. The method of claim 7, further comprising changing task routing to move at least some of a plurality of users to instances having lower security levels.

9. The method of claim 8, wherein moving at least some of the plurality of users comprises:
creating a user profile for each of the plurality of users;
periodically monitoring each user profile; and
calculating a confidentiality level for each of the plurality of users using the user profiles.

10. The method of claim 9, further comprising:
monitoring a number of active users for each instance of the application; and
responsive to the number of active users of a current instance being less than a predefined minimum number of profiles:
moving all users of the current instance to a higher security instance; and
removing the current instance.

11. A computer program product for intelligent routing, the computer program product comprising a computer readable storage medium having program instructions embodied therewith, the program instructions executable by a computer to perform a method comprising:
processing, by a first instance of an application, a plurality of tasks at a high security level;
receiving a new task from a user;
determining that the first instance cannot process the new task;
in response to determining that the first instance cannot process the new task:
analyzing the new task to determine an associated confidentiality level;
creating a second instance of the application to process the new task at the associated confidentiality level; and
processing the new task using the second instance at the associated confidentiality level.

12. The computer program product of claim 11, wherein determining that the first instance can process the new task comprises determining that a number of current users exceeds a threshold.

13. The computer program product of claim 12, wherein the method further comprises changing task routing to move at least some of a plurality of users to instances having lower security levels.

14. The computer program product of claim 13, wherein moving at least some of the plurality of users comprises:
creating a user profile for each of the plurality of users;
periodically monitoring each user profile; and
calculating a confidentiality level for each of the plurality of users using the user profiles.

15. The computer program product of claim 14, wherein the method further comprises:
monitoring a number of active users for each instance of the application; and responsive to the number of active users of a current instance being less than a predefined minimum number of profiles:
moving all users of the current instance to a higher security instance; and
removing the current instance.

16. A system for intelligent routing, the system comprising:
one or more processors; and
a memory communicatively coupled to the one or more processors;
wherein the memory comprises instructions which, when executed by the one or more processors, cause the one or more processors to perform a method comprising:
processing, by a first instance of an application, a plurality of tasks at a high security level;
receiving a new task from a user;
determining that the first instance cannot process the new task;
in response to determining that the first instance cannot process the new task:
analyzing the new task to determine an associated confidentiality level;
creating a second instance of the application to process the new task at the associated confidentiality level; and
processing the new task using the second instance at the associated confidentiality level.

17. The system of claim 16, wherein determining that the first instance can process the new task comprises determining that a number of current users exceeds a threshold.

18. The system of claim 17, wherein the method further comprises changing task routing to move at least some of a plurality of users to instances having lower security levels.

19. The system of claim 18, wherein moving at least some of the plurality of users comprises:
creating a user profile for each of the plurality of users;
periodically monitoring each user profile; and
calculating a confidentiality level for each of the plurality of users using the user profiles.

20. The system of claim 19, wherein the method further comprises:
monitoring a number of active users for each instance of the application; and responsive to the number of active users of a current instance being less than a predefined minimum number of profiles:
moving all users of the current instance to a higher security instance; and
removing the current instance.
